(19) United States
(12) Patent Application Publication
(10) Pub. No.: US 2020/0172050 A1
(43) Pub. Date: Jun. 4, 2020

(54) ONBOARD DEVICE VEHICLE MONITORING METHOD AND SYSTEM

(71) Applicant: GORDON*HOWARD ASSOCIATES, INC., Littleton, CO (US)

(72) Inventors: Ryan C. Schwarz, Denver, CO (US); Christopher M. Macheca, Centennial, CO (US); Todd Goodnight, Temecula, CA (US); Franco Chirico, Highlands Ranch, CO (US)

(73) Assignee: GORDON*HOWARD ASSOCIATES, INC., Littleton, CO (US)

(21) Appl. No.: 16/204,668

(22) Filed: Nov. 29, 2018

(51) Int. Cl. B60R 25/102; B60R 25/30; B60R 25/33

(52) U.S. Cl. CPC B60R 25/102; B60R 2025/1016; B60R 25/33; B60R 25/305

(57) ABSTRACT

A vehicle monitoring system for monitoring and providing real-time notification and vehicle-related information to a remotely located user is presented. A vehicle monitoring system can comprise a camera of a vehicle configured to capture video, a transceiver for wireless connectivity, a position sensor, and an onboard device. The onboard device, having a processor and a memory, can be configured to monitor position data from the position sensor, determine whether the position data exceeds a predetermined threshold, and generate a notification report when the position sensor data exceeds the predetermined threshold. The transceiver can be configured to transmit the notification report to a third-party device of a third-party. The vehicle monitoring system enables the user to receive timely and relevant information related to possible vehicle theft or unauthorized use of the vehicle.

### BACKGROUND

A vehicle owner or a third party, such as a lien holder, may have a concern for the care of a vehicle and the safety of vehicle occupants. Current vehicle protection systems include car alarms and vehicle trackers. A car alarm may deter would-be thieves by drawing attention to the vehicle via sounds and/or lights. However, a car alarm does not inform the vehicle owner of the attempted theft unless the owner is nearby. A car alarm also fails to provide information on what is occurring at the vehicle to cause the alarm. Vehicle trackers, such as a LoJack® system, can provide vehicle location information once activated. However, such trackers are typically used in theft recovery and only activated after a vehicle is stolen. Such tracker systems do not provide real-time notice or additional information beyond vehicle location. Therefore, what is needed is a system and method to monitor and provide real-time notification and vehicle-related information to a remotely located user.

### SUMMARY

Embodiments of the disclosure described in this specification relate generally to vehicle monitoring, and more particularly, to providing real-time visuals and notification of vehicle movement or other vehicle-related events. Those seeking to protect or monitor their vehicles may wish to have visual confirmation that the vehicle is safe from being stolen or unauthorized use. Such visual notification may aid in crime detection and prevention. For example, visual images or video captured by a recording device can be uploaded to a remote server. Subsequent review of the visual images can aid law enforcement in capturing perpetrators of vehicle theft and other crimes. Further, the presence of one or more recording devices in a vehicle may act as a deterrent against car thieves or unauthorized users.

In accordance with various embodiments, a vehicle monitoring system can comprise a camera of a vehicle configured to capture video, a transceiver for wireless connectivity, a position sensor, and an onboard device. The onboard device, having a processor and a memory, can be configured to monitor position data from the position sensor, determine whether the position data exceeds a predetermined threshold, and generate a notification report when the position sensor data exceeds the predetermined threshold. The transceiver can be configured to transmit the notification report to a third-party device of a third-party. The vehicle monitoring system monitors and provide real-time notification and vehicle-related information to a remotely located user, thereby enabling the user to receive timely and relevant information related to possible vehicle theft or unauthorized use of the vehicle.

### BRIEF DESCRIPTION OF THE DRAWINGS

For a detailed description of exemplary embodiments, reference will now be made to the accompanying drawings in which:

FIG. 1 shows a block diagram of a vehicle monitoring system in accordance with various embodiments;

FIG. 2 shows a block diagram of a vehicle monitoring system in accordance with various embodiments;

FIG. 3 shows a block diagram of a vehicle monitoring system in accordance with various embodiments;

FIG. 4 shows a block diagram of a portable electronic device in accordance with various embodiments;

FIG. 5 shows a method in accordance with various embodiments;

FIG. 6 shows a method in accordance with various embodiments;

FIG. 7 shows a method in accordance with various embodiments;

FIG. 8 shows a method in accordance with various embodiments; and

FIG. 9 shows a block diagram of a computer system in accordance with various embodiments.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections.

“Remote” or “remotely”, relative to a vehicle, shall mean a distance of greater than one kilometer.

“Identifying” shall mean making a determination as to the identity of a person or device, but shall not require determining an absolute identity. For example, determining that the person or device was not previously identified shall still be considered as identifying.

“Portable electronic device” shall mean a handheld device that has the ability to wirelessly communicate, and is not affixed to a vehicle. The fact that a portable wireless device may dock with a docking station while in a vehicle shall not obviate the portable status.

“Location” shall mean a geographic location, but shall not be read to require precise location.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure or claims. In addition, one skilled in the art will understand that the following description has broad application, and the discussion of any embodiment is meant only to be exemplary of that embodiment, and not intended to intimate that the scope of the disclosure or claims is limited to that embodiment.

In the following detailed description of the disclosure, numerous details, examples, and embodiments of a novel vehicle monitoring system and processes for reporting a vehicle-related event and providing a visual image or video captured of the vehicle-related event are described. In this description certain trademarks, word marks, and/or copyrights are referenced, including Wi-Fi®, which is a registered trademark of Wi-Fi Alliance, and Bluetooth®, which is a registered trademark owned by Bluetooth SIG, Inc. However, it will be clear and apparent to one skilled in the art that the roadway vehicle monitoring system is not limited to the embodiments set forth and that the vehicle monitoring system and processes for reporting a vehicle-related event and providing a video captured of the vehicle-related event can be adapted for any of several applications.

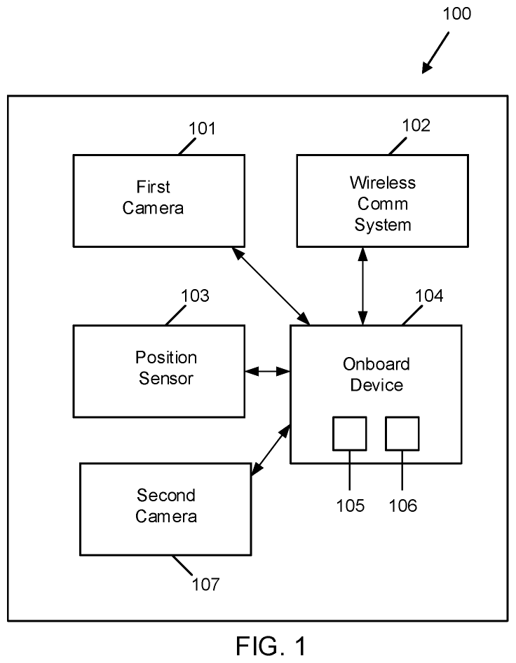

A vehicle monitoring system can be coupled to a vehicle, either as a built-in device or as an after-market accessory. In accordance with various embodiments and with reference to FIG. 1, the vehicle monitoring system 100 comprises a first camera 101 of a vehicle configured to capture video, a wireless communication system 102 for wireless connectivity, a position sensor 103, and an onboard device 104 coupled to the first camera 101, the wireless communication system 102, and the position sensor 103. The onboard device 104 comprises a memory 105 and a processor 106. The onboard device's processor 106 is configured to monitor position data from the position sensor 103, determine whether the position data exceeds a predetermined threshold, and generate a notification report when the position sensor data exceeds the predetermined threshold. In turn, the wireless communication system 102 is configured to transmit the notification report to a third-party device of a third-party. By way of example, the third-party may be the vehicle owner, a lien holder of the vehicle, emergency responders (e.g., police and/or fire departments), home security companies, insurance companies, or any other person or entity communicating with the vehicle monitoring system. Various embodiments and examples below may be described in terms of only a vehicle owner or only a lien holder for convenience, though one skilled in the art will understand that the embodiments are not limited and may be applied to other third-parties.

In accordance with various embodiments, the vehicle monitoring system 100 can further comprise a second camera 107 of the vehicle. The second camera 107 can capture video from a second viewpoint. For example, the first camera 101 can be an internal facing camera configured to capture a viewport internal to the vehicle, and the second camera 107 can be an external facing camera configured to capture a viewpoint external to the vehicle. In some embodiments, the first and/or second cameras are factory installed dash cameras. For instance, many of today's vehicles come equipped with one or more dash cameras, installed by the original vehicle manufacturer. In some embodiments, the first and/or second cameras are retrofit dash cameras installed into the vehicle after market. For example, a vehicle without factory installed dash cameras can benefit from the vehicle monitoring system 100 by installing commercially available dash cameras. With one camera providing an interior view of a vehicle and another camera providing an external view from the vehicle, the dash cameras are able to capture both interior and exterior videos continuously while the vehicle is on the road and the onboard device can save the videos as needed.

The cameras 101, 107 can operate when the vehicle is operating and the memory 105 temporarily stores video data of a predetermined duration for a time period for efficient memory management. The onboard device 104 can also permanently store video data in the memory 105 in other situations, such as when the notification report is generated. Furthermore, in various embodiments, the cameras 101, 107 may enter a sleep mode when the vehicle is not operating, and the cameras 101, 107 may enter an active mode when the vehicle is operating or when a location of the vehicle changes and the vehicle is not operating in order to conserve power. In yet other various embodiments, the cameras 101, 107 can be used to detect and capture motion within the vehicle when the vehicle is not operating. The camera capturing an interior view can be set to capture images at predetermined time intervals. The captured images can be processed to compare the images for differences, thereby indicating a change in the vehicle interior. In response to determining a change in the vehicle interior, a recent image can be sent to a third party for notification.

Furthermore, the onboard device 104 is coupled to, and receives the positioning data from, the position sensor 103. The position sensor 103 can be a global positioning system (GPS) sensor, an acceleration sensor such as an accelerometer, or any other sensor providing data on the position of the vehicle. Vehicle position may refer to a position within an area, or a current position with reference to a previous position. Using the positioning data, the onboard device 104 can determine whether the vehicle is moving. For example, changes in the vehicle's GPS coordinates or acceleration data indicate that the vehicle is moving or has moved. If the vehicle is moving, then the vehicle owner may be notified under certain conditions as will be described in further detail below. In this way, the vehicle owner receives notification when the reporting conditions are satisfied.

There are various situations where the embodiments disclosed herein provide a valuable service to the third-party receiving the notification report. The vehicle monitoring system 100 can notify of unauthorized vehicle movement or notify of authorized vehicle movement with beneficial information. One example is alerting a vehicle owner or lien holder in real-time when a vehicle is stolen. The camera's captured image or video can provide identification of a person stealing the car to either party. Another example is an alert if a vehicle is being towed. A third example is the vehicle is a company vehicle and notification reports are sent to help a company track the movements of an employee in the company vehicle. A fourth example is alerting a parent (vehicle owner) that the vehicle is moving and providing information regarding a child operating the vehicle. The notification report can include location information as well, thus the parent is alerted when a child is driving and also where the vehicle is located at that time. The captured image can also inform the vehicle owner of whom in the vehicle if the camera's field of view captures the vehicle interior.

In addition to detecting vehicle movement, in various embodiments when the position sensor is an accelerometer, the position sensor 103 can detect other events as well. For example, the position sensor 103 can detect contact with the vehicle, such as would occur during a door ding, fender bender, or window breaking. The resulting vibration can be detected by the accelerometer, and the onboard device 104 can determine a motion event has occurred and send a notification to the third-party device.

In accordance with various embodiments, the notification provided to the third-party device is at least one selected from a group of a notification report indicator, a partial notification report, or a full notification report. The notification report may include one or more of GPS coordinates (latitude/longitude), a video, a short messaging service (SMS) alert, at least one screenshot from video, a real-time video feed link, or at least one picture captured by the camera. The notification report may also include one or more of a timestamp of the notification report generation, a timestamp of when GPS coordinates were obtained, vehicle location (e.g., address if known), ignition status, vehicle speed (if moving), vehicle direction (if moving), and information on the notification trigger. For example, the notification report may alert the vehicle owner that the vehicle is moving in the form of an SMS alert or video message to the owner's mobile device. The SMS alert or video message can include a picture or video of the driver's seat captured by the camera so that the vehicle owner can identify a person operating the vehicle. In various embodiments, a notification report indicator may be an SMS alert, an application notification, or the like. Further, the partial notification report may comprise one or more of an SMS alert, an application notification, a captured image, a video clip, a real-time video feed link, or the like. A user may open a mobile phone application or other computer-based program after receiving the notification report indicator or the partial notification report for review, and have the option to access the full notification report.

If the third-party device receiving the notification report does not have the appropriate vehicle monitoring application or program installed, the onboard device 104 or a remote server can provide a link so that the appropriate application or program can be installed on the third-party device. For example, the download link can be provided as part of the notification report. The provided download link can be a Uniform Resource Locator (URL) or other link for a mobile phone, a tablet, or a computer to download the vehicle monitoring application. In various embodiments, the application installation may occur when adding new third-party device to list of receiving devices, which is completed by an administrator of the onboard device such as the vehicle owner. In other embodiments, the application installation may occur as part of a notification process.

The onboard device 104 may communicate with the third-party device in several ways. In a first embodiment, the onboard device 104 is configured to communicate with the third-party device via a cellular connection or other wireless connection. In a second embodiment, the onboard device 104 initially transmits the notification report to a remote server, which then communicates with the third-party device. Either the notification report indicator or the partial notification report can then be sent directly to the third-party device from the onboard device 104 via a cellular communication, where the onboard device 104 generates the notification report indicator or the partial notification report as needed. In a third embodiment, the notification report is sent to the remote server, and the remote server generates the notification report indicator or the partial notification report for sending to the third-party device. In these embodiments, the full notification report can be accessed by the third-party device from the remote server in response receiving the initial notification from either the onboard device 104 or the remote server.

As mentioned, the third-party may be notified of vehicle movement under certain preset conditions. However, most of the time a vehicle will be operating in a standard, authorized manner and vehicle owner will not want to receive constant notification reports every time the vehicle begins to move. Therefore, in accordance with various embodiments, a determination can be made whether to generate and/or send the notification report. Before generating and/or sending the notification report, the onboard device 104 can be further configured to identify a portable electronic device in communication with the vehicle, and determine whether a portable electronic device in communication with the vehicle is an authorized portable electronic device. The notification report can be generated when the portable electronic device in communication with the vehicle is not an authorized portable electronic device or a portable electronic device is not in communication with the vehicle. A portable electronic device can be: a cellular telephone, a smart phone, a computer system, a personal digital assistant, or a device comprising a radio frequency identification tag. For clarification, the portable electronic device used to determine whether an authorized user is present is not necessarily the same as the third-party device. For example, the portable electronic device may be a key fob used to identify a vehicle user, while the third-party device may be a smart phone. However, in some embodiments the portable electronic device may be the same as the third-party device.

The onboard device 104 can maintain a list of authorized portable electronic devices corresponding to authorized users of the vehicle to facilitate the identifying of authorized users. Many portable electronic devices can be in communication with a vehicle, such as a mobile phone paired with a vehicle via Bluetooth, or a Wi-Fi-enabled device connected to a Wi-Fi-enabled vehicle. Furthermore, the vehicle monitoring system's wireless communication system 102 can be configured to communicate with any number of portable electronic devices using wireless communications even if the vehicle itself is not equipped with Bluetooth or Wi-Fi. If an authorized portable electronic device is in communication with the vehicle when the vehicle moves, then the system can presume that the vehicle movement is authorized and the generation/transmission of the notification report is unnecessary. In this way, a vehicle owner can use the vehicle in a normal manner without receiving a notification report since the vehicle owner's mobile device would be on a list of authorized portable electronic devices.

As mentioned above, the onboard device 104 can maintain the list of authorized portable electronic devices corresponding to authorized users of the vehicle to facilitate the identifying of authorized users. The list of authorized portable electronic devices can be managed by a vehicle owner or other third parties to include devices associated with multiple people. A primary user, such as the vehicle owner, can have administrative status and set specific thresholds or preset conditions for each authorized device, including custom settings for secondary authorized users. For example, the vehicle monitoring system 100 can be programmed to have a first setting for authorized adult users (e.g., no notification report is sent when an associated portable electronic device is present) and a second setting for authorized child users (e.g., notification report sent when an associated portable electronic device is present). Further preset conditions may be added, such as day, time, or bounded location settings (e.g., notifications sent after 9 p.m.). The day or time settings may be applied in other situations as well, such as monitoring company vehicle movement during non-business hours or outside a preset geographic boundary. Further disclosure related to setting geographic boundaries can be found in U.S. Pat. No. 8,018,329, entitled “Automated geo-fence boundary configuration and activation”, which is hereby incorporated by reference in its entirety. In various embodiments, other preset conditions that may trigger the notification process can include temperature thresholds (interior and/or exterior temperature).

The embodiments described herein disclose determining whether position data exceeds a predetermined threshold. The position data could indicate the vehicle is moving, and any movement larger than a minor distance can trigger the next step in the monitoring process. For example, a minor distance can be a distance within the range of 1-5 feet, 1-10 feet, 1-25 feet, or 1-50 feet. In addition to these embodiments, a triggering event may also include an auto accident detected from acceleration data, a vehicle unlocking, whether the vehicle is moving when vehicle is not operating, acceleration data exceeding an acceleration threshold, vehicle speed exceeding a velocity threshold, or other alerts related to certain driving actions. The triggering event may also be based on motion detected within the vehicle interior by an interior camera when the vehicle is not operating. The motion detection could detect a vehicle break-in or send a notification if a pet or a child is accidently left in the vehicle.

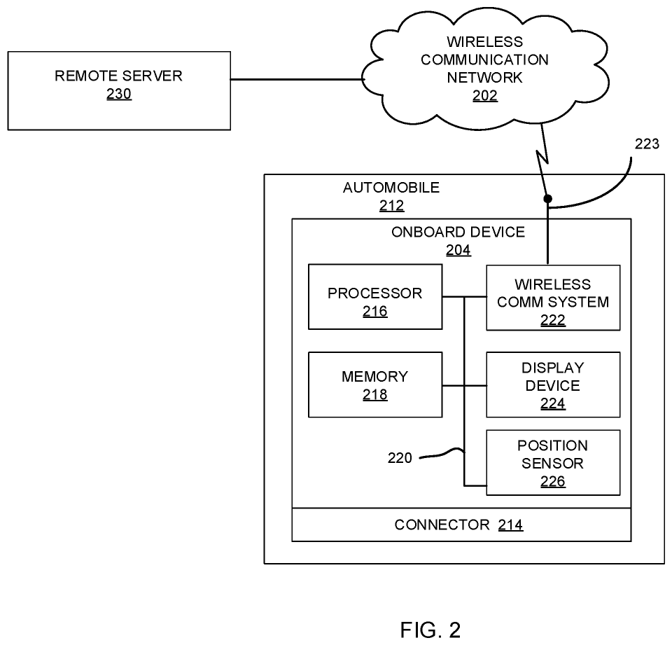

In order to provide a more complete disclosure of the vehicle monitoring system 100, embodiments of the various components and related processes will be described in greater detail. In various embodiments and as shown in FIG. 2, an onboard device 204 is coupled to a vehicle, such as automobile 212. That is, the onboard device 204 is mechanically and electrically coupled to the automobile 212, and in some cases at least a portion of the onboard device 204 is not physically accessible by an occupant properly seated in the vehicle. In many cases, some or all the onboard device 204 may reside under or within the dashboard of the automobile 212. In other cases, the onboard device 204 may be at any suitable location within the car, such as in an electrical compartment under the hood, or within the luggage compartment. In a particular embodiment, the onboard device 204 both mechanically and electrically couples to the automobile 212 by way of a connector 214. That is, connector 214 may provide mechanical support that holds the onboard device 204 in place, and by way of the connector 214 the onboard device 204 may electrically couple to other components of the automobile 212, such as the onboard computer or starter solenoid. In one embodiment, the connector 214 is an onboard diagnostic (OBD) version two (hereafter just OBD-II) port. Coupling the onboard device 204 to the OBD-II port thus gives the onboard device 204 the ability to communicate with one or more computer systems of the automobile 212.

The onboard device 204 illustrated in FIG. 2 comprises a processor 216 coupled to a memory 218 by way of a bus 220. The memory 218 stores programs executed by the processor 216, and in some cases may be the working memory for the processor 216. For example, the memory 218 may be random access memory (RAM) (e.g., dynamic random access memory (DRAM), flash memory), programmable read-only memory (PROM), or combinations. While FIG. 2 shows the processor 216 and memory 218 as separate components, in other cases the processor and memory are an integrated component, such as microcontroller. The processor 216 may communicate with sub-systems of the automobile over the connector 214, such as computer systems of the automobile. The onboard device 204 configured to couple to the OBD-II port may also have the ability to read or determine data associated with the vehicle, such as determining the vehicle speed or the identity of the vehicle (e.g., by reading the VIN number).

The onboard device 204 further comprises a wireless communication system 222 coupled to the processor 216. By way of the wireless communication system 222, programs executed by the processor 216 may communicate with other devices, such as a third-party device, a portable electronic device, or a remote server. In some embodiments, the wireless communication system 222 is the system over which data transmission to and from a remote server 230 may take place, as illustrated by antenna 223 coupled to the wireless communication network 202 and thus the remote server 230. The wireless communication system 222 thus implements a wireless communication system and/or protocol (i.e., radio frequency communication by way of electromagnetic waves propagating through air). Any suitable communication protocol may be implemented by the wireless communication system 222 and the wireless communication network 202, such as Global System for Mobile communications (GSM) compliant protocol, a General Packet Radio Service (GPRS) compliant protocol, or a Personal Communications Service (PCS) compliant system. In one embodiment the wireless communication system 222 will employ only data communications, but in other embodiments audio and/or voice communication from the remote server 230 may be implemented.

Still referring to FIG. 2, illustrative onboard device 204 further comprises a display device 224 coupled to the processor 216 in accordance with various embodiments. The display device 224 may be any display device upon which text and/or images may be formed. While in some embodiments portions of the onboard device 204 may not be accessible by the driver when properly seated, in a particular embodiment at the least the display device 224 is installed in such a way that the driver and/or other occupants of the automobile can see the display when properly seated. Though not specifically shown in FIG. 2, the display device may be overlaid with a transparent touch sensitive device such that the onboard device 204 implements “touch screen” functionality.

The illustrative onboard device 204 can further comprise a position sensor, such as a GPS receiver 226. The GPS receiver 226 receives signals from an array of GPS satellites orbiting the earth, and based on timing associated with arrival of those signals, a location of the onboard device 204 can be determined. In some cases, the GPS receiver 226 has sufficient functionality to calculate location, and thus the data passed to processor 216 may be a direct indication of location. In other cases, the functionality to determine location may be shared between the GPS receiver 226 and software executing on the processor 216. That is, the GPS receiver 226 may receive the plurality of GPS signals and pass the information to a program on the processor 216, which program may then make the determination as to location of the onboard device 204, and thus the location and movement of the automobile 212.

In other embodiments, location and movement determinations by the onboard device may be by mechanisms other than strictly GPS signals. For example, in some embodiments location may be fully or partially determined based on the signals of the wireless communication network 202 (which in some cases is a cellular telephone network). For example, location may be broadly determined by knowing the location of a particular tower of the wireless communication network 202 with which the onboard device 204 is communicating. In other cases, location may be determined by triangulation if multiple towers are in communication range of the wireless communication system 222 of the onboard device 204. In some cases, the determination of location based on the wireless communication network is performed by the processor 216 of the onboard device, but in other cases the tower information is sent to the remote server 230 to perform the bulk of the location and movement calculations.

In some cases, the location determined by the onboard device 204 may only be a position on the face of the earth, for example latitude and longitude. The remote server 230, receiving a stream of locations from the onboard device 204, may correlate to streets and addresses. In other cases, the onboard device 204 may have sufficient memory and computing functionality to not only determine position in a latitude and longitude sense, but also to correlate the position to cities, streets, block numbers and addresses.

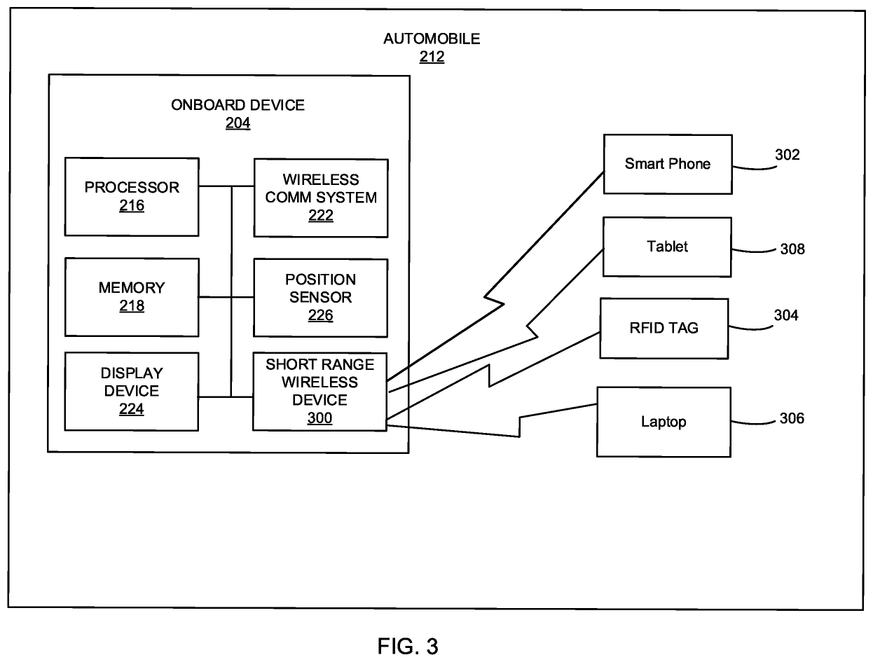

In various embodiments and with reference to FIG. 3, when the driver approaches and/or enters the automobile 212, the onboard device 204 identifies the driver via a portable electronic device. In accordance with some embodiments, the onboard device 204 identifies the portable electronic device by way of a short-range wireless device 300, which can be used to determine if an authorized user is present. More particularly, the short-range wireless device 300 may establish communication with a portable electronic device carried by the driver, and thereby identify the driver. That is, assuming that the driver usually carries the same portable wireless device, identifying the presence of the portable wireless device is thus an indirect identification of the driver. Portable wireless devices carried by the driver may take many forms. For example, the portable wireless device may be in the form of a cellular phone or smart phone 302, which smart phone 302 may provide personal digital assistant functionality.

In yet still further embodiments, the portable wireless device may be a radio frequency identification (RFID) tag 304 carried by the driver. For example, the driver may carry an access card for a building (e.g., work, gym) where the access card has an embedded RFID tag. The onboard device 204 may determine the driver identity by establishing communication with the RFID tag 304. In yet still further embodiments, the portable wireless device may be a laptop computer system 306 or a tablet 308 carried by the driver, where the laptop computer system 306 or the tablet 308 implements a short range communication system.

In the case of identifying by way of a portable wireless device then, identifying the device may thus indirectly identify the driver. However, these illustrative embodiments shall not be read to require that the full identity (e.g., full name) of the driver could or should be determined from the portable wireless device. In some cases merely knowing that a driver that regularly carries the particular portable wireless device may be sufficient. However, in some cases full identity may be determined, such as by reading the name entered by the user of the smart phone 302, or perhaps reading a name encoded on the RFID tag 304.

So as not to unduly complicate the description, the specification to this point has assumed that the driver is identified. However, in further embodiments the identified person need not be the driver. For example, by any of the various mechanisms discussed above, any occupant of the automobile 212 may be identified. Moreover, while the discussion is based on identifying a single individual, in other cases multiple individuals may be identified as being within the automobile.

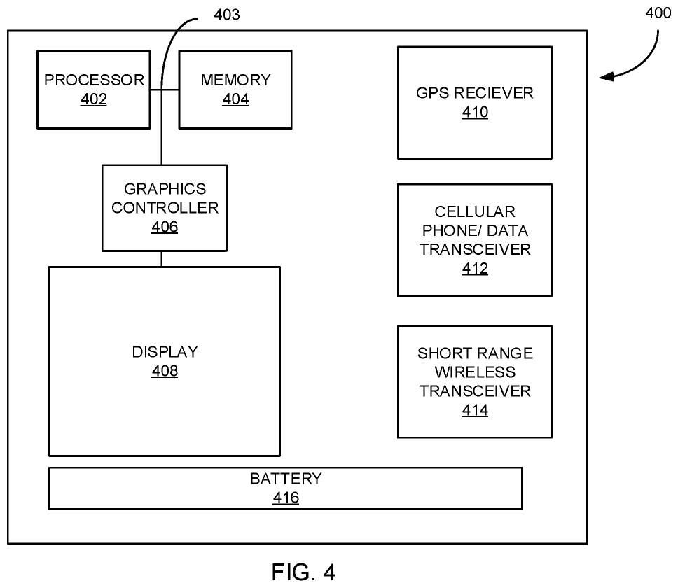

FIG. 4 shows an electrical block diagram of a portable electronic device 400 in accordance with at least some embodiments. The portable electronic device 400 is illustrative of devices that could be carried by the driver of the automobile, such as the smart phone 302. In particular, the portable electronic device 400 comprises a processor 402, memory 404, graphics controller 406, display device 408, GPS receiver 410, cellular phone/data transceiver 412, short range communication transceiver 414, and battery 416. The processor 402 is coupled to memory 404, such as by a bus 403. The memory 404 stores programs executed by the processor 402, and in some cases may be the working memory for the processor 402. In some cases, the memory 404 may be RAM (e.g., DRAM, flash memory). The memory 404 may store programs used by the portable electronic device for operation, such as a mobile operating system (e.g., iOS™ brand mobile operating system from Apple, Inc., or the ANDROID™ brand mobile operating system from Google, Inc.) and original equipment manufacturer (OEM) installed programs (e.g., applications to implement placing and receiving cellular phone calls, or messaging services).

An occupant who carries the portable electronic device 400 may interface with the various programs executed on the portable electronic device 400 by way of display device 408. The display device 408 may be any display device upon which text and/or images may be formed, such as a liquid crystal display (LCD). In some cases, the display device is controlled by graphics controller 406, but in other cases the graphics controller functionality may be implemented within the processor 402. Though not specifically shown in FIG. 4, the display device may be overlaid with a transparent touch sensitive device such that the portable wireless device implements “touch screen” functionality.

The illustrative portable electronic device 400 comprises the GPS receiver 410, which receives signals from an array of GPS satellites orbiting the earth, and based on timing associated with arrival of those signals, a location can be determined. In some cases, the GPS receiver 410 has sufficient functionality to calculate location, and thus the data passed to processor 402 may be a direct indication of location. In other cases, the functionality to determine position may be shared between the GPS receiver 410 and software executing on the processor 402. That is, the GPS receiver 410 may receive the plurality of GPS signals and pass the information to a program on the processor 402, which program may then make the determination as to location of the portable electronic device 400.

Still referring to FIG. 4, the portable electronic device may further comprise a cellular phone/data transceiver 412, over which voice and data transmission may take place. The transceiver 412 thus implements a wireless communication system and/or protocol (i.e., radio frequency communication by way of electromagnetic waves propagating through air). Any suitable communication protocol may be implemented by the transceiver 412, such as those implemented by the wireless communication network 202 (FIG. 2). While it is contemplated that in most cases the transceiver 412 will employ both voice and data communications, in some embodiments only a data communication system is implemented (e.g., an IPAD™ brand product available from Apple, Inc.). That is, in some cases the portable electronic device 400 does not provide voice services.

Still referring to FIG. 4, illustrative portable electronic device 400 further comprises a short range communication transceiver 414. By way of the short range communication transceiver 414, programs executed by the processor 402 may communicate with other devices, such as the onboard device 204. The protocol over which the short range communication transceiver 414 communicates may take many forms, but will be compatible with the protocol of the short range wireless communication device 300 of the onboard device 204.

A portable electronic device 400 such as shown in FIG. 4 enables additional functionality. For example, in some embodiments the GPS receiver 410 receives the satellite signals and determines location, and passes the location information to the onboard device 204. Moreover, as mentioned above the notification reports may be directly communicated to the third-party device by way of the cellular phone/data transceiver 412.

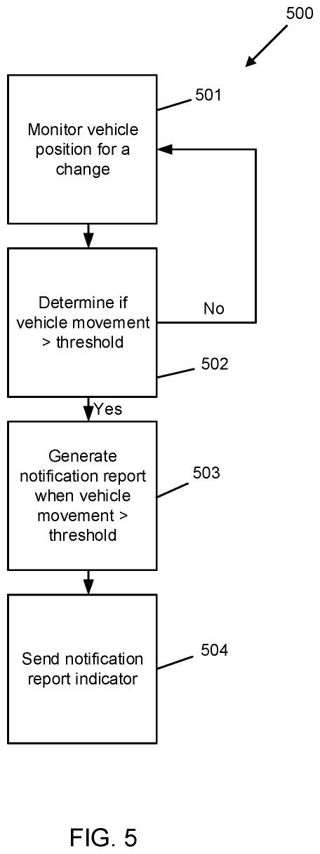

Various embodiments of vehicle monitoring methods will now be discussed. FIG. 5 shows a first method 500, some of which may be implemented by way of software and/or hardware in accordance with at least some embodiments. In particular, the first method 500 comprises: monitoring vehicle position for a change in position (501); determining if vehicle movement is greater than a threshold distance (502); returning to step 501 when the movement is less than the threshold distance; generating a notification report indicator when the movement is greater than the threshold distance (503); and sending a notification report indicator (504).

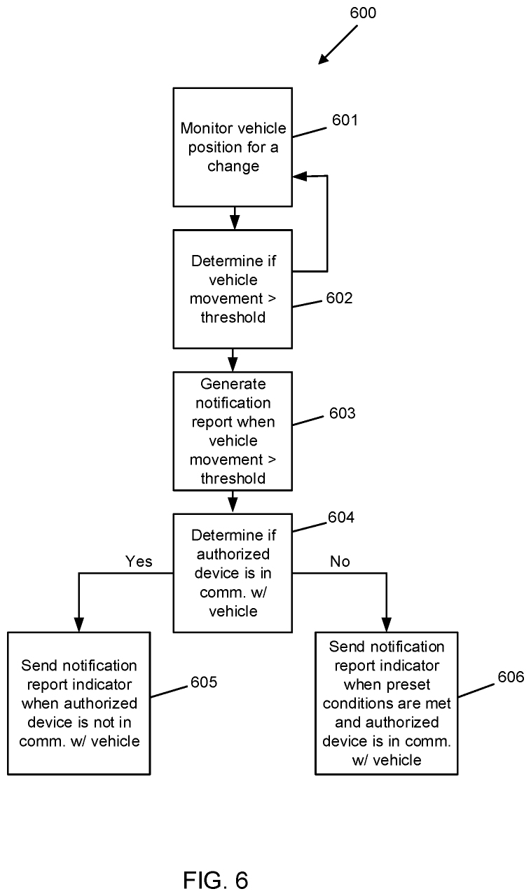

FIG. 6 shows a second method 600, some of which may be implemented by way of software and/or hardware in accordance with at least some embodiments. In particular, the second method 600 comprises: monitoring vehicle position for a change in position (601); determining if vehicle movement is greater than a threshold distance (602); returning to step 601 when the movement is less than the threshold distance; generating a notification report indicator when the movement is greater than the threshold distance (603); determining if an authorized device is in communication with the vehicle (604); sending the notification report indicator when the authorized device is not in communication with the vehicle (605); and sending the notification report indicator when the authorized device is in communication with the vehicle and preset conditions are met (606). The preset conditions can include the various preset conditions described above.

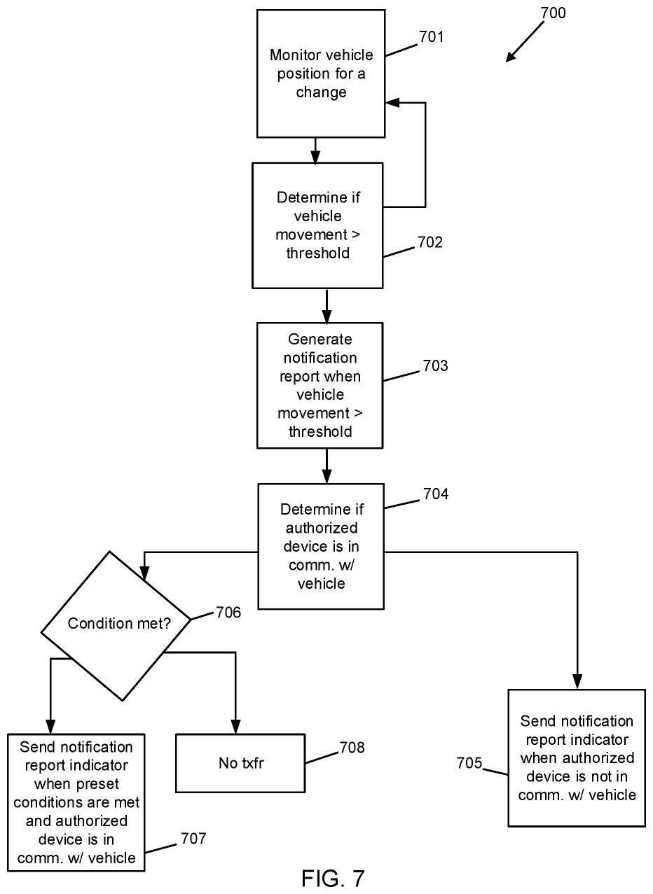

FIG. 7 shows a third method 700, some of which may be implemented by way of software and/or hardware in accordance with at least some embodiments. In particular, the third method 700 comprises: monitoring vehicle position for a change in position (701); determining if vehicle movement is greater than a threshold distance (702); returning to step 701 when the movement is less than the threshold distance; generating a notification report indicator when the movement is greater than the threshold distance (703); determining if an authorized device is in communication with the vehicle (704); sending the notification report indicator when the authorized device is not in communication with the vehicle (705); determining whether preset conditions are met when the authorized device is in communication with the vehicle (706); sending the notification report indicator when the authorized device is in communication with the vehicle and preset conditions are met (707); or not sending the notification report indicator when the authorized device is in communication with the vehicle and preset conditions are not met (708). The preset conditions can include the various preset conditions described above.

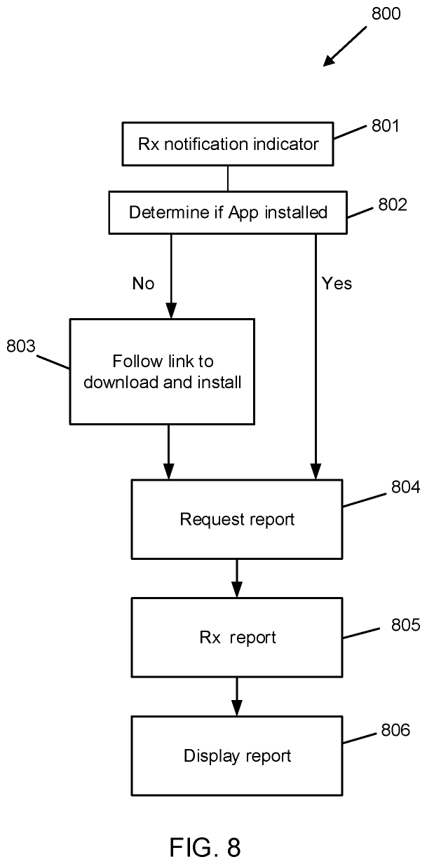

FIG. 8 shows a method 800 at a third-party device, some of which may be implemented by way of software and/or hardware in accordance with at least some embodiments. In particular, the method 800 comprises: receiving, by the third-party device, a notification report indicator (801); determining if an appropriate application to access the notification report is installed on the third-party device (802); if no, following a download link in the notification report indicator to download and install the appropriate application on the third-party device (803); requesting a notification report using information in the notification report indicator (804); receiving the notification report (805); and displaying the notification report on the third-party device (806).

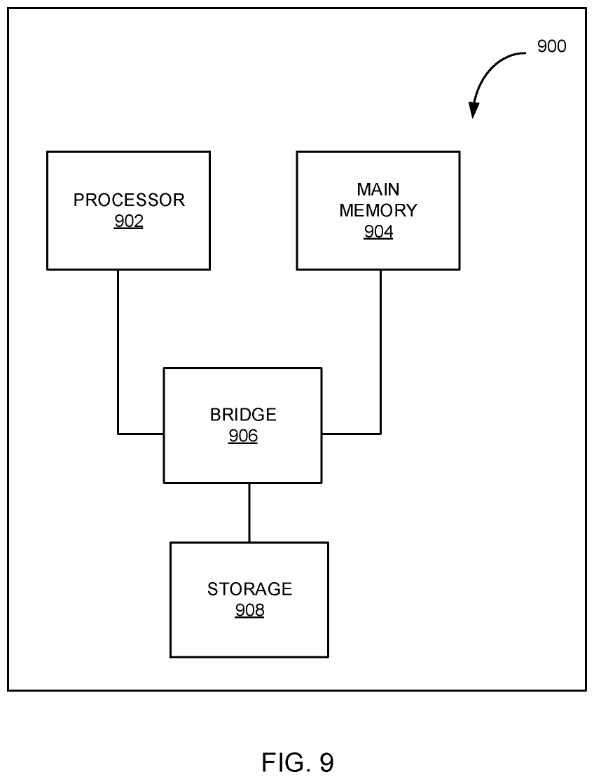

FIG. 9 illustrates a computer system 900 in accordance with at least some embodiments, and upon which at least some of the various embodiments of the remote server 230 may be implemented. That is, some or all of the various embodiments may execute on a computer system such as shown in FIG. 9, multiple computers systems such as shown in FIG. 9, and/or one or more computer systems equivalent to the FIG. 9, including after-developed computer systems.

In particular, the computer system 900 comprises a processor 902, and the processor couples to a main memory 904 by way of a bridge device 906. In some embodiments, the bridge device may be integrated with the processor 902. Moreover, the processor 902 may couple to a long term storage device 908 (e.g., a hard drive) by way of the bridge device 906. Programs executable by the processor 902 may be stored on the storage device 908, and accessed when needed by the processor 902. The programs stored on the storage device 908 may comprise programs to implement the various embodiments of the present specification, including monitoring vehicle movement, generating a notification report, determining when a notification report is to be transmitted under preset conditions. In some cases, the programs are copied from the storage device 908 to the main memory 904, and the programs are executed from the main memory 904. Thus, both the main memory 904 and storage device 908 are considered non-transitory computer-readable storage mediums.

In the specification and claims, certain components may be described in terms of algorithms and/or steps performed by a software application that may be provided on a non-transitory storage medium (i.e., other than a carrier wave or a signal propagating along a conductor). The various embodiments also relate to a system for performing various steps and operations as described herein. This system may be a specially-constructed device such as an electronic device, or it may include one or more general-purpose computers that can follow software instructions to perform the steps described herein. Multiple computers can be networked to perform such functions. Software instructions may be stored in any computer readable storage medium, such as for example, magnetic or optical disks, cards, memory, and the like.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, read-only memory (ROM), read-only compact discs (CD-ROM), recordable compact discs (CDR), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

References to “one embodiment”, “an embodiment”, “a particular embodiment”, “various embodiments” indicate that a particular element or characteristic is included in at least one embodiment of the invention. Although the phrases “in one embodiment”, “an embodiment”, “a particular embodiment”, and “various embodiments” may appear in various places, these do not necessarily refer to the same embodiment.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A vehicle monitoring system, comprising:
a camera of a vehicle configured to capture video;
a transceiver for wireless connectivity;
a position sensor configured to monitor a position of the vehicle; and
an onboard device coupled to the camera, the transceiver, and the position sensor, the onboard device comprising:
a memory configured to store executable instructions and video captured by the camera; and
a processor coupled to the memory and configured to:
monitor position data of the vehicle from the position sensor;
determine whether the position data exceeds a predetermined threshold;
determine whether a portable electronic device in wireless communication with the vehicle is an authorized portable electronic device; and
send a notification report indicator only when the authorized portable electronic device is not in communication with the vehicle, or is in communication with the vehicle and a preset condition is met, said preset condition comprising:
(a) a preset setting for an authorized adult user of the vehicle;
(b) a preset setting for an authorized child user of the vehicle; and
(c) a preset setting for an authorized user during preset hours or geographic boundary.

2. (canceled)

3. The vehicle monitoring system of claim 1, wherein the processor is further configured to identify the portable electronic device selected from the group consisting of: a cellular telephone, a smart phone, a computer system, a personal digital assistant, or a device comprising a radio frequency identification tag.

4. (canceled)

5. The vehicle monitoring system of claim 1, wherein the processor is further configured to forward the notification report indicator to a third-party vehicle owner or a lien holder.

6. The vehicle monitoring system of claim 1, wherein the position sensor is at least one of a global positioning system (GPS) sensor or an acceleration sensor.

7. The vehicle monitoring system of claim 1, wherein the notification report indicator comprises one or more of GPS coordinates, a video, a text alert, at least one screenshot from video, a real-time video feed link, or at least one picture captured by the camera.

8. The vehicle monitoring system of claim 1, further comprising a second camera of a vehicle configured to capture video from a second viewpoint.

9. The vehicle monitoring system of claim 8, wherein the camera is an internal facing camera configured to capture a viewport internal to the vehicle, and wherein the second camera is an external facing camera configured to capture a viewpoint external to the vehicle.

10. The vehicle monitoring system of claim 1, wherein the camera operates when the vehicle is operating and the memory temporarily stores video data of a predetermined duration for a time period, and wherein the memory permanently stores video data when the notification report is generated, and wherein the camera enters a sleep mode when the vehicle is not operating, and wherein the camera enters an active mode when the vehicle is operating or when the position of the vehicle changes while the vehicle is not operating.

11. A vehicle monitoring method, comprising:
capturing, by a camera of a vehicle, a video;
monitoring, by a position sensor, a position of the vehicle;
monitoring, by an onboard device coupled to the camera and the position sensor, position data of the vehicle from the position sensor;
determining, by the onboard device, whether the position data exceeds a predetermined threshold;
determining, by the onboard device, whether a portable electronic device in wireless communication with the vehicle is an authorized portable electronic device; and
sending a notification report indicator only when the authorized portable electronic device is not in communication with the vehicle, or is in communication with the vehicle and a preset condition is met, said preset condition comprising:
(a) a preset setting for an authorized adult user of the vehicle;
(b) a preset setting for an authorized child user of the vehicle; and
(c) a preset setting for an authorized user during preset hours or geographic boundary.

12. (canceled)

13. The vehicle monitoring method of claim 11, further comprises communicating with the portable electronic device selected from the group consisting of: a cellular telephone, a smart phone, a computer system, a personal digital assistant, or a device comprising a radio frequency identification tag.

14. (canceled)

15. The vehicle monitoring method of claim 11, further comprising forwarding the notification report indictor to a third-party vehicle owner or a lien holder.

16. The vehicle monitoring method of claim 11, wherein the position sensor is at least one of a global positioning system (GPS) sensor or an acceleration sensor.

17. The vehicle monitoring method of claim 11, wherein the notification report indicator comprises one or more of GPS coordinates, a video, a text alert, at least one screenshot from video, a real-time video feed link, or at least one picture captured by the camera.

18. The vehicle monitoring method of claim 11, further comprising a second camera of a vehicle configured to capture video from a second viewpoint.

19. The vehicle monitoring method of claim 18, wherein the camera is an internal facing camera configured to capture a viewport internal to the vehicle, and wherein the second camera is an external facing camera configured to capture a viewpoint external to the vehicle.

20. The vehicle monitoring method of claim 11, wherein the camera operates when the vehicle is operating and the memory temporarily stores video data of a predetermined duration for a time period, and wherein the memory permanently stores video data when the notification report is generated, and wherein the camera enters a sleep mode when the vehicle is not operating, and wherein the camera enters an active mode when the vehicle is operating or when the position of the vehicle changes while the vehicle is not operating.
